(19) United States
(12) Patent Application Publication
(10) Pub. No.: US 2005/0002178 A1
(43) Pub. Date: Jan. 6, 2005

(54) Apparatus for adjusting biological clock of a traveler

(76) Inventors: Jenny Wu, Keelung City (TW); Guang-Chyeng Fan, Hsinchu City (TW)

Correspondence Address: RABIN & BERDO, P.C., Suite 500, 1101 14th Street, N.W., Washington, DC, 20005, US

(21) Appl. No.: 10/611,158

(22) Filed: Jul. 2, 2003

(51) Int. Cl. F21V 21/08

(52) U.S. Cl. 362/103

(57) ABSTRACT

An apparatus for adjusting the biological clock of a traveler is constructed to has a body, which can be made in the form of an article of clothing for wear by a user or a footstool for resting the user's legs, and a light source installed in the body and used to emit light of a wavelength within about 400 nm-700 nm to irradiate a part of the body of the traveler having many blood vessels relatively close to the surface, a location at which light interacts with photoactive substances in the blood.

### BACKGROUND OF THE INVENTION

1. Field of the Invention

The present invention relates to a therapeutic apparatus and, more specifically, to an apparatus for adjusting the biological clock of a traveler where light interacts with photoactive substances in the blood.

2. Description of the Related Art

Humans have biological clocks that are set to the dark/light cycles caused by the rotation of the earth around its own axis. The human body adjusts its biological clock subject to the change of light between day and night. When the rhythm is broken, the phase response curve is caused to shift forwards or backwards, thereby causing a person to be unable to wake up or to sleep through the night.

Following the advent of aviation, jet lag has become a problem for the body's biological clock. Travelers may have to spend one or two additional days resting and adjusting to the time of day at a new location.

Research from Science 279: 333-334 (January 1998); S. S. Campbell, and P. J. Murphy, has shown that the biological clock may be readjusted by shining a light on the popliteal region of the body, located at the back of a patient's knees.

U.S. Pat. No. 6,164,787 discloses an apparatus for adjusting the biological clocks of travelers. The apparatus comprises a light source 10, a light conduit 11, a luminaire 12, and a fan 13. The light conduit 11 is connected between the light source 10 and the luminaire 12. The light source 10 is a halogen lamp. The fan 13 is adapted to dissipate heat from the halogen lamp. Light from the light source 10 is transmitted through the light conduit 11 to the luminaire 12 to shine bright light on the backs of the knees of the traveler. This permits adjustment of the biological clock of the traveler in flight.

The aforesaid apparatus has a complicated structure and high manufacturing cost. It consumes much electric energy and produces noises during operation. When in use, the user needs to wear a pair of short trousers so that the backs of the knees of the traveler can receive sufficient light from the light source.

### SUMMARY OF THE INVENTION

The present invention has been accomplished under the circumstances in view. It is the main object of the present invention to provide an apparatus for adjusting the biological clock of a traveler, which apparatus is simple and inexpensive to manufacture. It is another object of the present invention to provide an apparatus for adjusting the biological clock of a traveler, which apparatus consumes less electric energy and does not produce noise when operated. It is still another object of the present invention to provide an apparatus for adjusting the biological clock of a traveler, which apparatus is convenient in use without requiring the user to wear a pair of short trousers. To achieve these and other objects of the present invention, the apparatus for adjusting the biological clock of a traveler comprises a body, and a light source installed in the body and adapted to emit light of a wavelength within 400 nm-700 nm to irradiate a part of the body of the traveler having many blood vessels relatively close to the surface, a location at which light interacts with photoactive substances in the blood. The body can be made in the form of a piece of clothing worn by the user, or a footstool for resting the user's legs.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates the arrangement of a circadian clock seat according to U.S. Pat. No. 6,164,787;

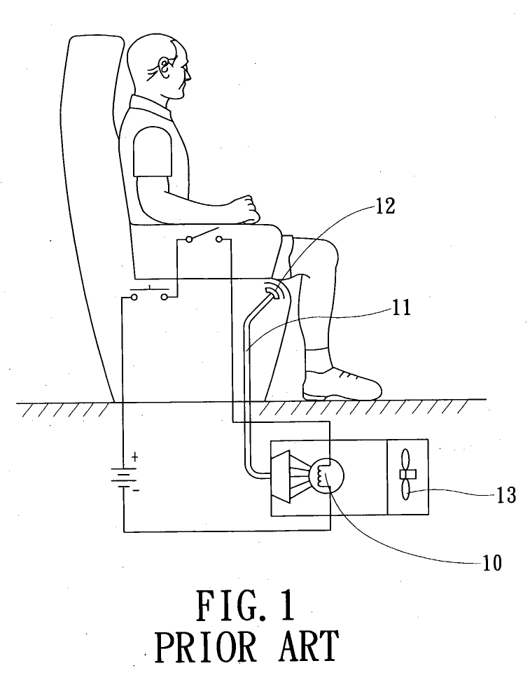

FIG. 2 is a schematic drawing showing the radiation of the circadian clock seat according to U.S. Pat. No. 6,164,787;

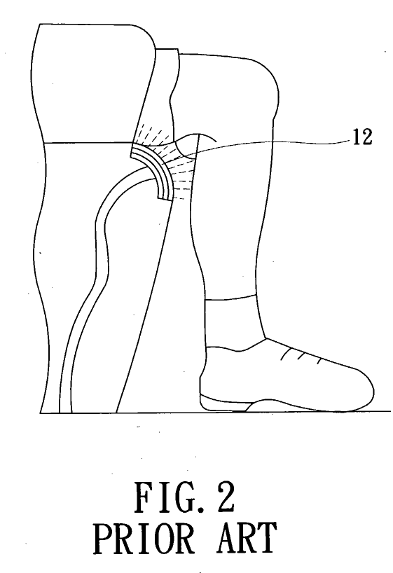

FIG. 3 is a schematic drawing showing the arrangement of an apparatus for adjusting the biological clock of a traveler according to the present invention;

FIG. 4 illustrates an application example of the apparatus for adjusting the biological clock of a traveler according to the present invention; and

FIG. 5 is a schematic drawing showing an alternate form of the apparatus for adjusting the biological clock of a traveler according to the present invention.

### DETAILED DESCRIPTION OF THE PREFERRED EMBODIMENT

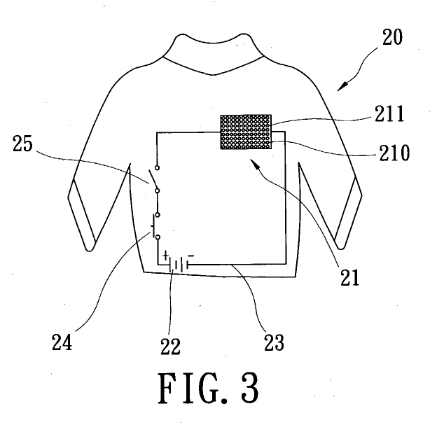

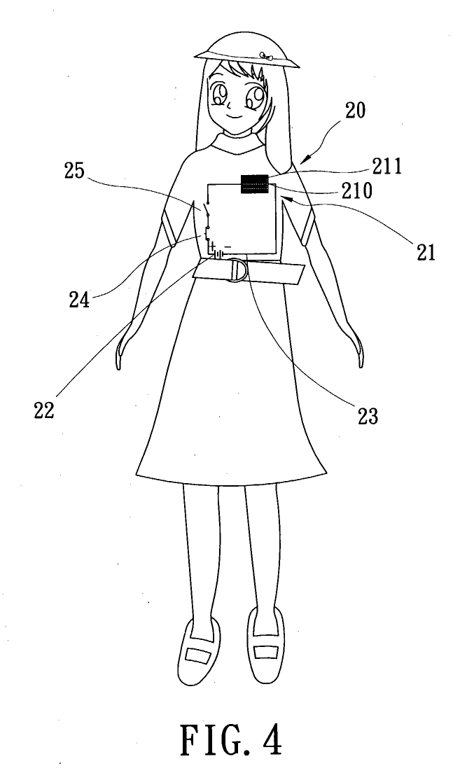

Referring to FIGS. 3 and 4, an apparatus for adjusting the biological clock of a traveler in accordance with the present invention is shown comprised of a body 20, a light source 21, and a power supply unit 22. The structure and shape of the body 20 may be variously embodied. For example, the body 20 can be made in the form of a shirt, vest, or the like to be worn on the body of a person (see FIG. 4).

The light source 21 is comprised of a number of LEDs (light emitting diodes) 210 mounted in the body 20 and adaptable to emit light of a predetermined intensity, for example, 13,000 lux up and a predetermined wavelength, for example, 400 nm-760 nm to illuminate a part of the body of the user. The light source 21 is mounted in a precision ceramic 211 in the body 20 adjacent to the LEDs 210. The precision ceramic 211 is made from mineral materials such as aluminum oxide, zircon oxide, titanium dioxide, or yttrium trioxide. When the LEDs 210 is electrically connected to emit light, the precision ceramic 211 is excited to emit far-infrared rays that penetrate the user's skin in the irradiated area to stimulate the circulation of blood.

The power supply unit 22 is installed in the body 20 at a suitable location, and electrically connected to the light source 21 through an electric wire 23 to provide the necessary working power to the light source 21. Switches 24 and 25 are installed in the electric wire 23 for controlling on/off status of the light source 21.

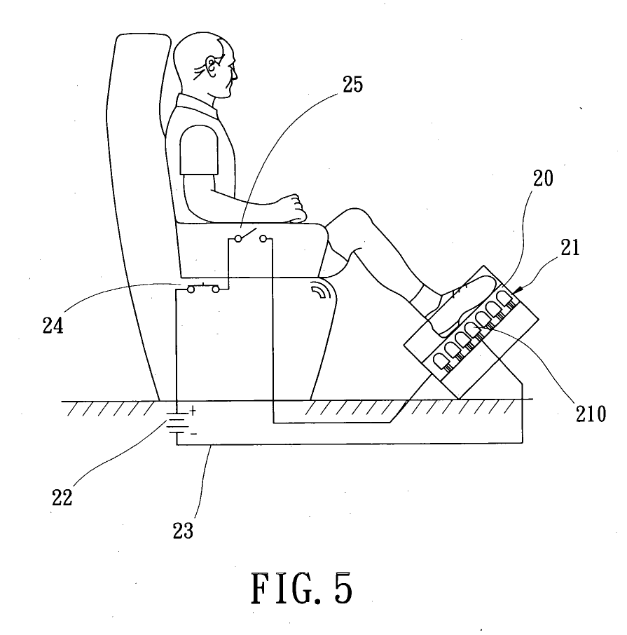

Referring to FIG. 5, the body 20 can be made in the form of a footstool. The user can sit on a seat with his or her legs resting on the footstool 20 to receive radiation from the light source 21.

The apparatus for adjusting the biological clock of a traveler is preferably used three hours before landing when taking a long flight. The light source is used to irradiate a part of the body having many blood vessels relatively close to the surface, a location at which light interacts with photoactive substances in the blood.

As indicated above, the invention achieves adjustment of the biological clock of a traveler by applying far-infrared rays to a part of the traveler's body that has many blood vessels relatively close to the surface. The strength and temperature of the radiation are preferably about 13,000 lux-30,000 lux and about 40-45° C., respectively.

The manufacturing cost of the apparatus for adjusting the biological clock of a traveler is low because it has a simple structure. Further, because LEDs are used for the light source, the apparatus consumes less power. Since the invention eliminates the use of a cooling fan, the apparatus does not produce noises during operation. Additionally, the apparatus can be comfortably worn directly on the body. When in use, the user needs not wear a pair of short trousers as necessitated by the use of a conventional design.

A prototype of an apparatus for adjusting the biological clock of a traveler has been constructed with the features of the annexed drawings of FIGS. 3-5. The apparatus for adjusting the biological clock of a traveler functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. An apparatus for adjusting the biological clock of a traveler, the apparatus comprising:
a body; and
a light source installed in said body, said light source comprising a plurality of light emitting diodes used to emit light of a wavelength within about 400 nm-700 nm.

2. The apparatus as claimed in claim 1, wherein said body is adapted to be worn on the body of the user.

3. The apparatus as claimed in claim 1, wherein said body has a shape of a footstool for resting of legs of the traveler.

4. The apparatus as claimed in claim 1, further comprising a power supply unit electrically connected to said light source by an electric wire and an on/off switch means installed on said electric wire.

5. The apparatus as claimed in claim 1, further comprising a precision ceramic disposed adjacent to said light emitting diodes and used to emit a far-infrared ray when excited by light from said LEDs.
